(19) United States
(12) Patent Application Publication
(10) Pub. No.: US 2004/0098193 A1
(43) Pub. Date: May 20, 2004

(54) Navigation apparatus

(76) Inventor: Tatsumi Kageyama, Tokyo (JP)

Correspondence Address: BIRCH STEWART KOLASCH & BIRCH, PO BOX 747, FALLS CHURCH, VA, 22040-0747, US

(21) Appl. No.: 10/691,606

(22) Filed: Oct. 24, 2003

(30) Foreign Application Priority Data
Nov. 1, 2002 (JP) 2002-320175

(51) Int. Cl. G01C 21/26

(52) U.S. Cl. 701/207; 701/200; 340/988

(57) ABSTRACT

A navigation apparatus determines whether a correction-type-vs.-brain-wave-pattern storing unit stores a correction pattern substantially matching a brain wave pattern produced from a detected brain wave signal by comparing the brain wave pattern with a plurality of types of correction patterns pre-stored in the storing unit, and then determines whether or not an issue of a corresponding correction instruction is appropriate based on the detected current position of a moving object and the one displayed on a display unit when determining that a correction pattern substantially matching the recognized pattern exists in the storing unit. The navigation apparatus then makes a correction to a screen display showing the current position of the moving object according to the correction instruction when determining that an issue of the correction instruction is appropriate.

### BACKGROUND OF THE INVENTION

1. Field of the Invention

The present invention relates to a navigation apparatus for guiding a moving object, such as a vehicle or ship, so that the moving object can travel by way of an optimum route.

2. Description of Related Art

There has been provided a prior art navigation apparatus equipped with a dangerous operation notification function, which can expect the occurrence of a danger before the driver carries out a dangerous operation of a vehicle and which can inform the user that a danger will occur, thereby improving the driving safety.

The prior art navigation apparatus, which determines the current position of the vehicle based on a GPS signal by using a GPS antenna unit and which reads map information stored in a CD-ROM by using a CD access unit based on this current position and displays the map information on a display unit thereof, grasps information about roads to which the vehicle will be able to be headed in advance by using a road detecting unit after the CD access unit has acquired the map information about a map of an area with center at the current position acquired by the GPS antenna unit. A safety evaluating unit estimates what the user will do from the user's brain wave acquired by a brain wave detecting unit and further estimates a road along which the user will drive the vehicle so as to evaluate the safety of the road. As a result, when the safety evaluating unit evaluates that the driver's predicted action is dangerous, a notification unit notifies the danger of the action to the driver (for example, refer to Japanese patent application publication (TOKKAIHEI) No. 7-182595 (see paragraph numbers “0007”, “0008”, and “0009”)).

On the other hand, even when the displayed current position of a moving object, such as a vehicle or ship, is different from an actual position, a general prior art navigation apparatus doesn't correct the displayed current position of the moving object if the difference between them falls within the tolerance of the current position determined by using a GPS signal. Therefore, when the user determines that the displayed current position is different from an actual position, the user needs to conduct complex work, such as a movement of a mark indicating the current position of the moving object to an on-screen position corresponding to the actual position by operating a key so as to move an on-screen cursor. Even the prior art navigation apparatus that evaluates the safety of a road along which the user will drive the moving object based on brain wave information obtained by the brain wave detecting unit cannot eliminate such complex work. In other words, a problem with the prior art navigation apparatus is that when the user determines that the displayed current position of a moving object such as a vehicle is different from an actual position, the user needs to conduct complex work. Furthermore, in a case of a navigation apparatus intended for vehicles, when a vehicle is moving at a speed equal to or larger than 5 km per hour, key operations are prohibited according to the specifications of the navigation apparatus. Therefore, the driver has to temporarily stop the vehicle in order to conduct complex correction work.

### SUMMARY OF THE INVENTION

The present invention is proposed to solve the above-mentioned problems, and it is therefore an object of the present invention to provide a navigation apparatus that, when a displayed current position of a moving object, such as a vehicle or ship, is different from an actual current position, can correct the displayed current position of the moving object while it is moving without having to carry out error correction such as automatic correction (map matching) and without users having to conduct complex correction work.

In accordance with the present invention, there is provided a navigation apparatus including an instruction detecting unit for detecting a correction instruction signal indicating a correction instruction for making a correction to a screen display on a display unit and showing the current position of a moving object detected by a position detecting unit as a guided target for navigation, and for producing a recognized pattern based on the correction instruction signal, a storage unit for storing a plurality of types of correction patterns corresponding to a plurality of types of corrections to be made to the screen display, a pattern determination unit for determining whether the storage unit stores a correction pattern substantially matching the recognized pattern by comparing the recognized pattern with the plurality of types of correction patterns, a correction instruction determining unit for determining whether or not an issue of the correction instruction is appropriate based on the current position of the moving object and the one shown by the screen display on the display unit when the pattern determination unit determines that a correction pattern substantially matching the recognition pattern exists, and a screen display correction unit for making a correction to the screen display on the display unit and showing the current position of the moving object according to the correction instruction when the correction instruction determining unit determines that an issue of the correction instruction is appropriate.

Therefore, when the displayed current position of the vehicle is different from an actual current position, the navigation apparatus can correct the displayed current position of the vehicle while the vehicle is moving without having to carry out error correction such as automatic correction (map matching) and without users having to conduct complex correction work.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the system configuration of a navigation apparatus in accordance with embodiment 1 of the present invention;

FIG. 2 is a block diagram showing the internal structure of a brain wave processing unit, and a relationship between the brain wave processing unit and a signal processing unit, in the navigation apparatus in accordance with embodiment 1 of the present invention;

FIG. 3 is a flow chart showing main processing performed by an arithmetic unit of the navigation apparatus in accordance with embodiment 1 of the present invention;

FIG. 4 is a flow chart showing pattern recognition processing of FIG. 3;

FIGS. 5A to 5C are diagrams each showing a screen display produced during the pattern recognition processing as shown in FIG. 4, the screen display showing the name of a correction associated with a correction pattern that is stored in the navigation apparatus of embodiment 1;

FIG. 6 is a flow chart showing brain wave detection processing of FIG. 3;

FIG. 7 is a flow chart showing correction instruction judgment processing of FIG. 6;

FIG. 8 is a diagram showing a relationship between the current position of a vehicle that is determined during the correction instruction judgment processing and the current position of the vehicle that is determined by using a GPS signal;

FIGS. 9A and 9B are diagrams showing a correction that is made to the current position of the vehicle displayed on a display of the navigation apparatus in accordance with embodiment 1 of the present invention;

FIG. 10 is a block diagram showing the system configuration of a navigation apparatus in accordance with embodiment 2 of the present invention; and

FIG. 11 is a block diagram showing the internal structure of a brain wave processing unit, and a relationship between the brain wave processing unit and both a signal processing unit and a voice recognition processing unit, in the navigation apparatus in accordance with embodiment 2 of the present invention.

### DETAILED DESCRIPTION OF THE PREFERRED EMBODIMENTS

In general, human being's brain waves have a frequency band ranging from 0 Hz to a few hundreds of Hz. In accordance with “An evaluation of user interface with emotions,” (UNISYS TECHNOLOGY REVIEW No. 64, February 2000) by Mr. Hirokazu Tagaito, brain waves can be measured as a theta wave of 5 to 8 Hz, an alpha wave of 8 to 13 Hz, and a beta wave of 13 to 20 Hz by using an emotion spectrum analysis method. This emotion spectrum analysis method includes the steps of bringing 10 electrodes into contact with a human being's head, detecting a potential that appears between one pair of two arbitrary ones of the 10 electrodes as an EEG signal, and amplifying the EEG signal so as to measure the human being's brain wave.

Therefore, there are 45 possible pairs of two electrodes that can be selected from the 10 electrodes. When theta, alpha, and beta EEG signals of three frequency bands are measured for each of the 45 possible pairs of two electrodes, 135 correlation coefficients in total are acquired. By then extracting features concerning “anger/stress”, “joy”, “sadness”, and “relaxation” that are human emotional elements, 540 correlation coefficients are determined for analysis of brain waves.

Hereafter, navigation apparatuses intended for vehicles and using EEG signals in accordance with embodiments 1 and 2 will be explained based on the above-mentioned research paper and well-known other studies of brain waves.

### Embodiment 1

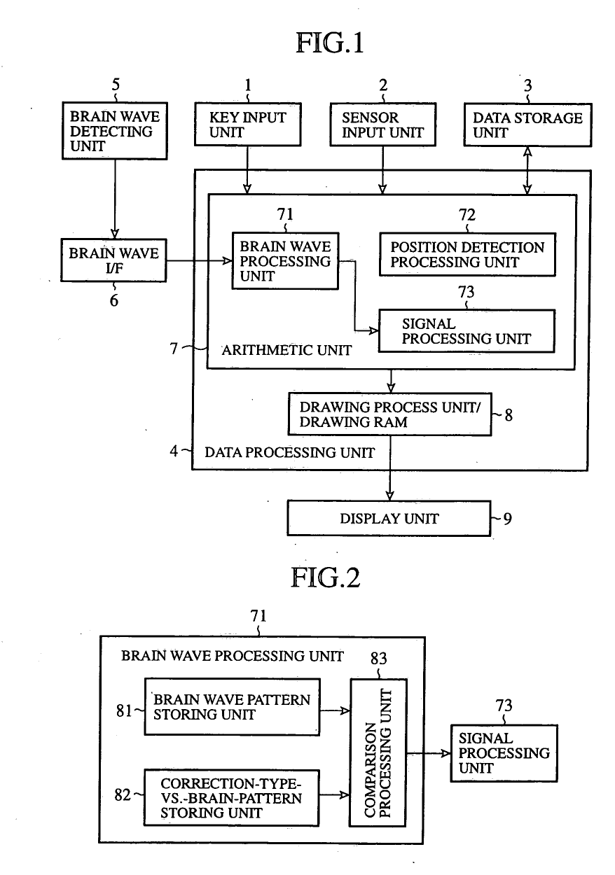

FIG. 1 is a block diagram showing the system configuration of a navigation apparatus intended for vehicles in accordance with embodiment 1. In this figure, a key input unit 1 (i.e., an operation means) receives an instruction input by a user according to the user's operation. A sensor input unit 2 (i.e., an information input means) receives information such as the current position, bearing, and speed of a vehicle, in which the navigation apparatus is installed, from a GPS receiver, a gyro, a velocity sensor, and so on. A data storage unit 3 temporarily stores map data, data necessary for navigation and so on. A data processing unit 4 processes various data used for navigation. A brain wave detecting unit 5 (i.e., an instruction detecting means and a brain wave detecting means) detects a brain wave from contact electrodes or noncontact electrodes attached to the driver's head and generates and delivers a brain wave (or EEG) signal (i.e., an instruction signal). A brain wave interface unit 6 carries out signal processing, such as amplification and level adjustment, on the brain wave signal delivered from the brain wave detecting unit 5, and delivers the processed brain wave signal to the data processing unit 4.

The data processing unit 4 consists of an arithmetic unit 7 and a drawing processing unit and drawing RAM 8. The arithmetic unit 7 performs arithmetic processing on the processed brain wave signal from the brain wave interface unit 6 in order to make a correction to the displayed current position of the vehicle. The drawing processing unit and drawing RAM 8. (i.e. an image correction means) creates drawing data on a map to be displayed, drawing data on the current position of the vehicle, and drawing data used for the correction of the current position of the vehicle based on data calculated by the arithmetic unit 7. A display unit 9 (i.e., a display means) displays the map, the current position of the vehicle and so on based on the drawing data created by the drawing processing unit and drawing RAM 8 on a screen thereof.

The arithmetic unit 7 is comprised of a brain wave processing unit 71, a position detection processing unit 72, and a signal processing unit 73. The brain wave processing unit 71 processes the brain wave signal received from the brain wave interface unit 6. The position detection processing unit 72 (i.e., a position detecting means) detects the current position of the vehicle according to positional information acquired from the sensor input unit 2. The signal processing unit 73 (i.e., a correction instruction determination means) performs a correction instruction process and a correction instruction determination process based on data acquired from the brain wave processing unit 71.

FIG. 2 is a block diagram showing the internal structure of the brain wave processing unit 71 and a relationship between the brain wave processing unit 71 and the signal processing unit 73. As shown in this figure, the brain wave processing unit 74 is comprised of a brain wave pattern storing unit 81 for storing a brain wave pattern produced from a brain wave signal therein, a correction-type-vs.-brain-wave-pattern storing unit 82, and a comparison processing unit 83. The brain wave pattern storing unit 81 temporarily stores a brain wave pattern (i.e., a recognized pattern) that is produced based on a brain wave signal, which is generated by the brain wave detecting unit 5 and is delivered thereto by way of the brain wave interface unit 6. The correction-type-vs.-brain-wave-pattern storing unit 82 (i.e., a storing means) is provided with a learning function, and pre-stores a plurality of brain wave patterns as a plurality of correction patterns while associating the plurality of brain wave patterns with a plurality of types of corrections (referred to as correction types from here on), respectively, each of which is to be made to a screen display (i.e., an on-screen map) showing the current position of the vehicle, by carrying out pattern recognition processing. The comparison processing unit 83 (i.e., a pattern determination means) compares the brain wave pattern (i.e., the recognized pattern) temporarily stored in the brain wave pattern storing unit 81 with the plurality of correction patterns stored in the correction-type-vs.-brain-wave-pattern storing unit 82.

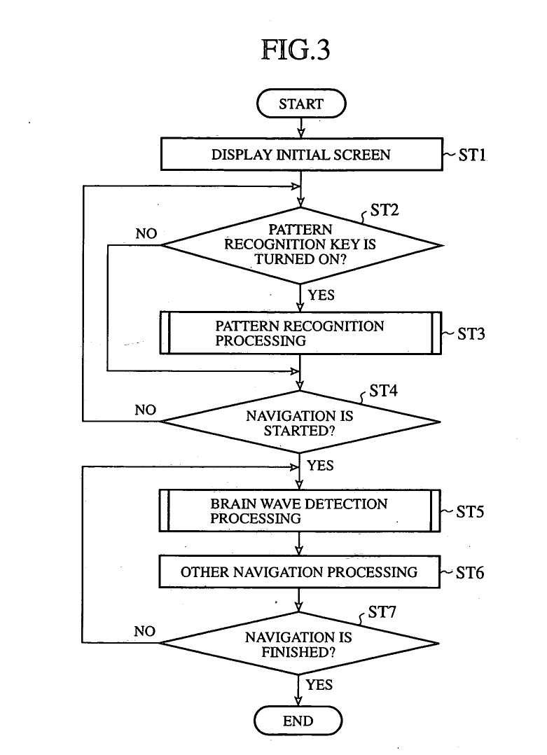

Next, a description will be made as to an operation of the navigation apparatus in accordance with embodiment 1. FIG. 3 is a main flow chart showing processes carried out by the arithmetic unit 7. First of all, the arithmetic unit 7 displays an initial screen display (in step ST1) through which the user is allowed to select either one of a plurality of modes, such as pattern recognition mode (i.e., brain wave pattern registration mode), navigation mode and so on, and determines whether or not a pattern recognition key on the key input unit 1 is turned on (in step ST2). When the pattern recognition key is turned on the arithmetic unit 7 carries out pattern recognition processing (in step ST3). When the pattern recognition key is not turned on or when the pattern recognition processing is complete, the arithmetic unit 7 determines whether or not navigation is started (in step ST4). The arithmetic unit 7 can recognize a start of navigation when a navigation start key on the key input unit 1 is turned on or when the driver starts to drive the vehicle.

When determining that the navigation is started, the arithmetic unit 7 carries out brain wave detection processing (in step ST5). The arithmetic unit 7 can further perform other navigation processing (in step ST6). The arithmetic unit 7 then determines whether or not the navigation has been finished (in step ST7). The arithmetic unit 7 continues the brain wave processing of step ST5 when the navigation has not been finished yet, whereas the arithmetic unit 7 stops the flow as shown in FIG. 3 when the navigation has been finished.

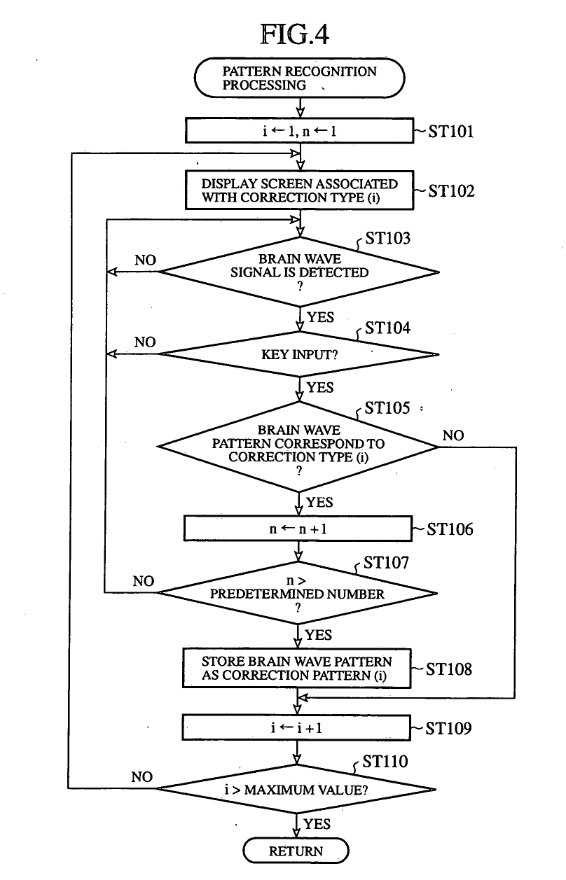

FIG. 4 is a flow chart showing the pattern recognition processing of step ST3 in the main flow of FIG. 3. In this flow, the arithmetic unit 7 sets both a first pointer i for specifying a correction typo (i) that is associated with a brain wave pattern (i.e., a correction pattern) stored in the correction-type-vs.-brain-wave-pattern storing unit 82 and a second pointer n for indicating the number of times which the user has performed a key input operation to “1” (in step ST101), and carries out processes of steps ST102 to ST110 while incrementing the first and second pointers i and n.

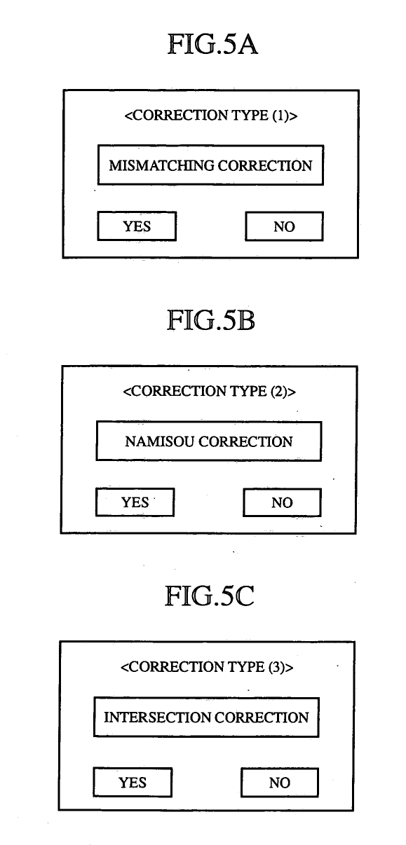

In step ST102, the arithmetic unit 7 produces a screen display showing the name of the correction type (i) specified by the first pointer i. Each of FIGS. 5A to 5C is a diagram showing a produced screen display of the name of the correction type (i) associated with a correction pattern (i). FIG. 5A shows a screen display of the name of “Mismatching Correction (i.e., the correction type (1))” associated with the correction pattern (1), FIG. 5B shows a screen display of the name of “Namisou Correction ( i.e., the correction type (2))” associated with the correction pattern (2), and FIG. 5C shows a screen display of the name of “Intersection Correction (i.e., the correction type (3)” associated with the correction pattern (3). In addition, the arithmetic unit 7 can produce screen displays each showing the name of another correction, such as “Matching Cancel (Correction-Free Display Mode) (i.e., the correction type (4))”, “Highway Matching Correction (i.e., the correction type (5))”, or “Learning Reset (i.e., the correction type (6))”, although they are not shown in the figure. On each of the screen displays as shown in FIGS. 5A to 5C, an icon “YES” which the user selects when he or she desires to make the corresponding correction to a screen display (which is not actually shown on the display unit in the brain wave pattern registration mode) and an icon “NO” which the user selects when he or she does not desire to make the corresponding correction to a screen display are displayed together with the name of the correction type (i) associated with the correction pattern (i). The user selects either of the two icons by performing a key input operation.

The correction-type-vs.-brain-wave-pattern storing unit 82, which is disposed in the brain wave processing unit 71 of the arithmetic unit 7, can learn about brain wave patterns obtained from brain wave signals from the user's head when the user desires the navigation apparatus to make a correction to an erroneous screen display of a mark indicating the current position of the vehicle so that the mark actually indicates a correct current position of the vehicle, and stores a brain wave pattern which is acquired from the learned about brain wave patterns, as a correction pattern associated with “Mismatching correction”, therein. When the user desires the navigation apparatus to make a correction to an erroneous screen display in which the vehicle can be assumed to be traveling along a road along which the vehicle is not actually traveling so that the screen display shows that the vehicle is traveling along another road along which the vehicle is actually traveling and which is substantially parallel to the above-mentioned road, the correction-type-vs.-brain-wave-pattern storing unit 82 can learn about brain wave patterns obtained from brain wave signals from the user's head and store a brain wave pattern which is acquired from the learned about brain wave patterns, as a correction pattern associated with “Namisou Correction”, therein. When the user desires the navigation apparatus to make a correction to an erroneous screen display in which the vehicle can be assumed to be traveling along a road extending from an intersection to which the vehicle is not actually headed so that the screen display shows that the vehicle is traveling along another road extending from another intersection adjacent to the above-mentioned intersection, the other road being substantially parallel to the above-mentioned road, the correction-type-vs.-brain-wave-pattern storing unit 82 can learn about brain wave patterns obtained from brain wave signals from the user's head and store a brain wave pattern which is acquired from the learned about brain wave patterns, as a correction pattern associated with “Intersection Correction”, therein. When the user drives the vehicle in a parking area, for example, and desires the navigation apparatus to cancel the correction that is being made to an erroneous screen display in which the vehicle can be assumed to be traveling along a road along which the vehicle is not actually traveling, i.e., when the user desires a correction-free screen display, the correction-type-vs.-brain-wave-pattern storing unit 82 can learn about brain wave patterns obtained from brain wave signals from the user's head and store a brain wave pattern which is acquired from the learned about brain wave patterns, as a correction pattern associated with “Matching Cancel (Correction-Free Display Mode)”. When the user desires the navigation apparatus to make a correction to an erroneous screen display in which the vehicle can be assumed to be traveling along a highway (or a general road) along which the vehicle is not actually traveling so that the screen display shows that the vehicle is traveling along a general road (or a highway) along which the vehicle is actually traveling and which is substantially parallel to the above-mentioned road, the correction-type-vs.-brain-wave-pattern storing unit 82 can learn about brain wave patterns obtained from brain wave signals from the user's head and store a brain wave pattern which is acquired from the learned about brain wave patterns, as a correction pattern associated with “Highway Matching Correction”, therein. A screen display showing “Learning Reset” is produced in order to, when the brain wave detection mechanism of step ST5 of FIG. 3, which is based on the plurality of types of correction patterns acquired by the pattern recognition processing, doesn't work properly, clear the plurality of types of correction patterns that are stored in the correction-type-vs.-brain-wave-pattern storing unit 82 while being associated with the plurality of correction types, respectively, and to allow the user to select the brain wave pattern registration mode in which the arithmetic unit can learn about brain wave patterns so as to register brain wave patterns as the plurality of correction patterns.

After producing a screen display associated with the correction pattern (i) instep ST102 of FIG. 4, the arithmetic unit 7 determines whether it has detected a brain wave signal (in step ST103). When the arithmetic unit 7 has detected a brain wave signal, it produces a brain wave pattern from the detected brain wave signal, and further, in step ST104, determines whether or not the user carries out a key input operation. When the user carries out a key input operation, the arithmetic unit 7 determines whether the key input is “YES” or “NO”. When the key input is “YES”, the arithmetic unit 7 determines that the user has desired the navigation apparatus to make the displayed correction corresponding to the correction pattern (i) (i.e., the correction type(i)) to an erroneous on-screen map, which is not actually displayed on the display unit 9. In contrast, when the key input is “NO”, the arithmetic unit 7 determines that the user has not desired the navigation apparatus to make the displayed correction corresponding to the correction pattern (i) to an erroneous on-screen map.

In step ST105, the arithmetic unit 7 determines whether the brain wave pattern acquired in step ST103 corresponds to the correction type (i) specified by the displayed name of the correction. In other words, the arithmetic unit 7 determines whether the key input in step ST104 is “YES” or “NO”. When determining that the acquired brain wave pattern corresponds to the correction type (i), the arithmetic unit 7 increments the second pointer n by only “1” (in step ST106). The arithmetic unit 7 then determines whether the second pointer n exceeds a predetermined value (e.g., 3, 4, or 5) (in step ST107). When the second pointer n is equal to or less than the predetermined value, the arithmetic unit 7 repeats the processes of steps ST103 to ST107. In contrast, when the second pointer n exceeds the predetermined value, that is, when the user has carried out a key input indicating that the brain wave pattern acquired in step 102 corresponds to the correction type (i) selected in step 102 the predetermined number of times, the arithmetic unit 7 stores a brain wave pattern, which is acquired from the n learned about brain wave patterns, in the correction-type-vs.-brain-wave-pattern storing unit 82 while associating the brain wave pattern with the correction type (i) (in step ST108). In other words, the arithmetic unit 7 stores the brain wave pattern which is acquired from the n learned about brain wave patterns, as the correction pattern (i), in the correction-type-vs.-brain-wave-pattern storing unit 82.

At this time, the arithmetic unit 7 can average the n brain wave patterns which the arithmetic unit 7 acquires by repeating step ST103 the predetermined number of times and store the average of the n detected brain wave patterns, as the correction pattern (i), in the correction-type-vs.-brain-wave-pattern storing unit 82. As an alternative, the arithmetic unit 7 can acquire a waveform pattern including parts whose absolute levels exceed a threshold level from either one of the n detected brain wave patterns, and store the acquired waveform pattern, as the correction pattern (i), in the correction-type-vs.-brain-wave-pattern storing unit 82. Alternatively, after calculating the average of the n detected brain wave patterns, the arithmetic unit 7 can acquire a waveform pattern including parts whose absolute levels exceed a threshold level from the average. The method of determining the correction pattern (i), which is to be stored in the correction-type-vs.-brain-wave-pattern storing unit 82, from the n detected, learned-about brain wave patterns while associating the correction pattern (i) with the correction type (i) is not limited to any one of the above-mentioned methods.

The arithmetic unit 7 then increments the first pointer i by only “1” (in step ST109), and determines whether the first pointer i exceeds its maximum value (in step ST110). In other words, the arithmetic unit 7 determines whether it has finished the storing process of storing a brain wave pattern for each of all the correction types. When the first pointer i is equal to or less than the maximum value and there is one or more correction types to be associated with brain wave patterns which have not been stored yet in the correction-type-vs.-brain-wave-pattern storing unit 82, the arithmetic unit 7 shifts to step ST102 in which it repeats the above-mentioned processes up to step ST110. In contrast, when the first pointer i exceeds the maximum value, the arithmetic unit 7 finishes this flow of FIG. 4 and returns to the main flow of FIG. 3.

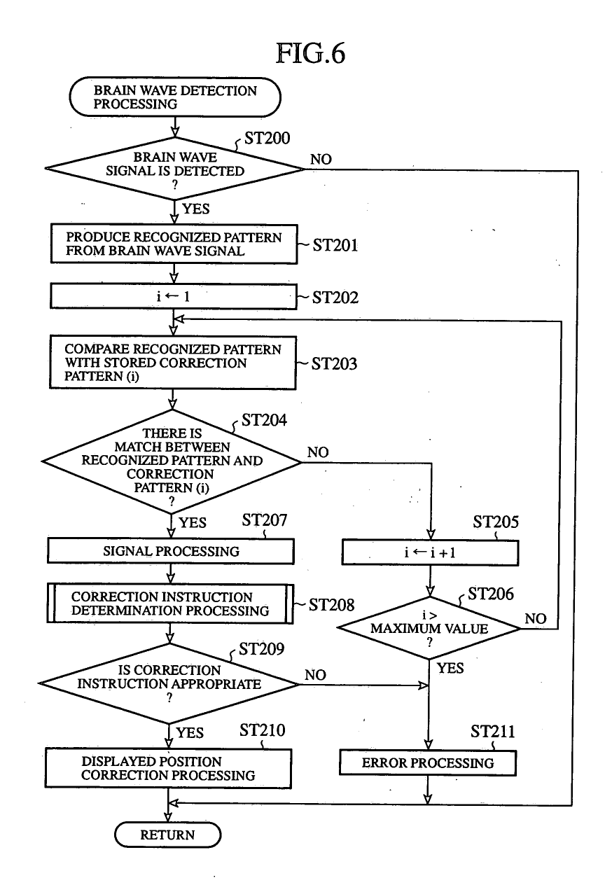

FIG. 6 is a flow chart showing the brain wave detection processing of step ST5 in the main flow. The arithmetic unit 7 determines whether or not it has detected a brain wave signal (in step ST200). When the arithmetic unit 7 has detected a brain wave signal, it produces a recognized pattern based on the detected brain wave signal and stores it in the brain wave pattern storing unit 81 (in step ST201). The arithmetic unit 7 then sets the first pointer i specifying the correction pattern (i) stored in the correction-pattern-vs.-brain wave-pattern storing unit 82 to “1” (in step ST202). After that, th arithmetic unit 7 searches for a correction pattern that substantially matches the recognized pattern while incrementing the pointer i.

In other words, the arithmetic unit 7 compares the recognized pattern with the stored correction pattern (i) associated with the correction type (i), in step ST203, so as to determine whether the recognized pattern substantially matches the correction pattern (i) stored in the correction-type-vs.-brain wave-pattern storing unit 82 (in step ST204). When the recognized pattern does not substantially match the correction pattern (i) associated with the correction type (i), the arithmetic unit 7 increments the pointer i by only “1” (in step ST205). At this time, the arithmetic unit 7 further determines whether the pointer i exceeds its maximum value (in step ST206). When the pointer i is equal to or less than the maximum value, the arithmetic unity 7 shifts to step ST203 in which it compares the recognized pattern with the next correction pattern associated with the next correction type (i). In contrast, when the recognized pattern substantially matches the correction pattern associated with the correction type (i) in step ST204, the arithmetic unit 7 carries out signal processing based on the correction type (i) corresponding to the correction pattern (in step ST207). The arithmetic unit 7 then carries out correction instruction determination processing based on a result of the signal processing (in step ST208).

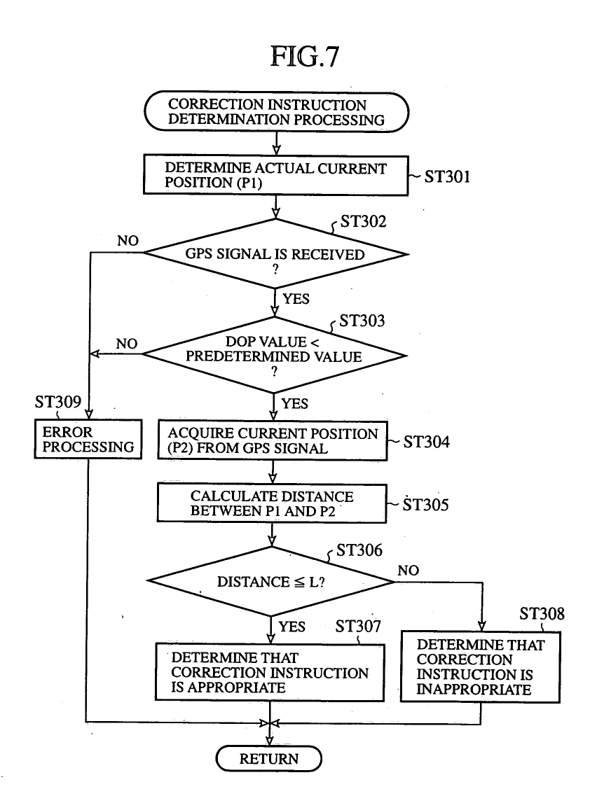

FIG. 7 is a flow chart showing the correction instruction determination processing. First of all, the arithmetic unit 7 determines the actual current position (P1) of the vehicle based on a result of the signal processing which is carried out based on the correction type corresponding to the correction pattern that is determined to substantially match the recognized pattern (in step ST301). The arithmetic unit 7 then determines whether it has received a GPS signal (in step ST302). When the arithmetic unit 7 has received the GPS signal, the arithmetic unit 7 determines whether or not a DOP value included in the GPS signal is less than a predetermined value (in step ST303). The DOP value is an index value indicating the degree of deterioration of the accuracy of the position detection using the GPS signal. When the DOP value is less than the predetermined value, it can be assumed that a sufficient degree of accuracy of the position detection is achieved. In contrast, when the DOP value is equal to or greater than the predetermined value, it can be assumed that an insufficient degree of accuracy of the position detection is achieved.

When the DOP value is less than the predetermined value, the arithmetic unit 7 acquires the current position (P2) of the vehicle by using the received GPS signal (in step ST304). The arithmetic unit 7 then calculates the distance between the determined current position (P1) of the vehicle and the current position (P2) of the vehicle calculated by using the GPS signal (in step ST305). The arithmetic unit 7 further determines whether or not the calculated distance falls within a range from 0 to L (in step ST306). When the calculated distance falls within the range from 0 to L, the arithmetic unit 7 determines that the following issue of a corresponding correction instruction is appropriate (in step ST307). On the other hand, when the calculated distance does not fall within the range from 0 to L, the arithmetic unit 7 determines that the following issue of a corresponding correction instruction is inappropriate (in step ST308).

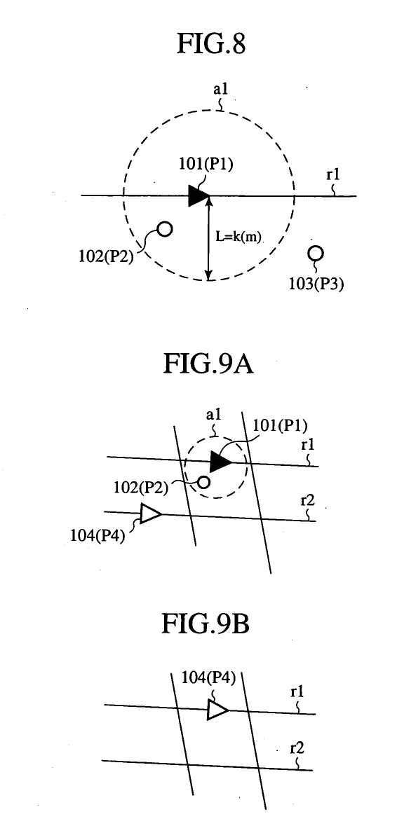

FIG. 8 is a diagram showing a relationship between the current position (P1) of the vehicle, which is located on a road r1 and is determined by carrying out the signal processing based on the determined correction type, and the current position 102 (P2) or 103 (P3) of the vehicle, which is determined by using a GPS signal. When the current position of the vehicle which is determined by using a GPS signal is the one 102 (P2), the arithmetic unit 7 determines that the following issue of a corresponding correction instruction is appropriate because the current position 102 is located within a circular region a1, as shown by a dotted line, of radius L=k meters and with center at the current position 101 which is determined by carrying out the signal processing based on the correction type. On the other hand, when the current position of the vehicle which is determined by using a GPS signal is the one 103 (P3), the arithmetic unit 7 determines that the following issue of a corresponding correction instruction is inappropriate because the current position 102 is located outside the circular region a1.

When the navigation apparatus cannot detect any GPS signal in step ST302, or when the arithmetic unit 7 determines that the DOP value included in the detected GPS signal is equal to or greater than the predetermined value, in step ST303, the arithmetic unit 7 carries out error processing because the arithmetic unit 7 cannot determine whether or not the determined current position (P1) is appropriate (in step ST309). The arithmetic unit 7 returns to step ST209 of the flow of FIG. 6 after carrying out the determination processing of step ST307 or ST308, or after carrying out the error processing of step ST309.

The arithmetic unit 7, in step ST209, determines whether or not the following issue of the correction instruction associated with the recognized pattern produced in step ST201 is appropriate according to the result of the correction instruction determination processing as shown in the flow of FIG. 7. When the following issue of the correction instruction is appropriate, the arithmetic unit 7 carries out displayed-position correction processing (in step ST210). FIGS. 9A and 9B show an example of the corresponding correction that is made to the current position of the vehicle displayed on the display unit of the navigation apparatus in accordance with embodiment 1 of the present invention. For example, as shown in FIG. 9A, when the current position 102 which is determined by using a GPS signal is located within a circular region a1 with center at the current position 101, which is located on a road r1 and which will be determined by carrying out the signal processing based on the determined correction type, and the displayed current position 104 (P4) is located on a road r2, a brain wave signal indicating “Namisou correction” as shown in FIG. 5B can originate from the driver.

In this case, the correction type (2) corresponding to a correction pattern that substantially matches the recognized pattern produced based on the brain wave signal is already read out of the correction-type-vs.-brain-wave-pattern storing unit 82, in step S207. The displayed-position correction processing is thus carried out based on the correction type (2) in step ST210 of FIG. 6. As a result, as shown in FIG. 9B, the mark indicating the current position 104 (P4) and displayed on the road r2 is corrected so that it is moved to and indicates an actual current position located on the road r1 that is parallel to the road r2.

When the determination result of step ST209 of FIG. 6 shows that the following issue of the correction instruction is inappropriate based on the result of the correction instruction determination processing as shown in the flow of FIG. 7, or when the pointer i exceeds the maximum value and no correction pattern that substantially matches the recognized pattern is stored in the correction-type-vs.-brain wave-pattern storing unit 82, in step ST206, the arithmetic unit 7 carries out error processing (in step ST211). In each of this error processing and the error processing of step ST309 of FIG. 7, an error description is displayed on the display unit.

As mentioned above, in accordance with this embodiment 1, the navigation apparatus includes the brain wave detecting unit 5 for generating a brain wave signal indicating a correction instruction for instructing the arithmetic unit 7 to make a correction to a screen display showing the current position of a vehicle displayed on the display unit 9. The arithmetic unit 7 is provided with the brain wave processing unit 71 for processing the brain wave signal from the brain wave detecting unit 5, the position detection processing unit 72 for detecting the current position of the vehicle based on positional information acquired from the sensor input unit 2, and the signal processing unit 73. The arithmetic unit 7 compares a recognized pattern that is produced based on the brain wave signal indicating the correction instruction with a plurality of types of correction patterns pre-stored in the correction-type-vs.-brain-wave-pattern storing unit 82 so as to determine whether a correction pattern substantially matching the recognized pattern exists in the correction-type-vs.-brain-wave-pattern storing unit 82. When a correction pattern substantially matching the recognized pattern exists in the correction-type-vs.-brain-wave-pattern storing unit 82, the arithmetic unit 7 determines whether or not the following issue of the correction instruction is appropriate based on the current position of the vehicle detected by the position detection processing unit 72 and the one shown by the screen display on the display unit. When the following issued of the correction instruction is appropriate, the arithmetic unit 7 makes a correction to the screen display showing the current position of the vehicle according to the correction instruction.

Therefore, when the displayed current position of the vehicle is different from an actual current position, the navigation apparatus can correct the displayed current position of the vehicle while the vehicle is moving without having to carry out error correction such as automatic correction (map matching) and without users having to conduct complex correction work.

In a variant of above-mentioned embodiment 1, in addition to the mechanism of making a correction to the displayed current position of the vehicle according to a correction instruction signal that is generated based on a brain wave signal, the navigation apparatus can have a mechanism of making a correction to the displayed current position of the vehicle according to an operation of the key input unit 1. As an alternative, the navigation apparatus can have either a mechanism of detecting a movement of the driver's specific part, such as a hand, by using an electromagnetic wave sensor or infrared sensor, and making a correction to the displayed current position of the vehicle according to a correction instruction signal that is generated based on the detected movement of the driver, or a mechanism of detecting a movement of the driver's line of vision by using a camera, and making a correction to the displayed current position of the vehicle according to a correction instruction signal that is generated based on the detected movement of the driver's line of vision.

### Embodiment 2

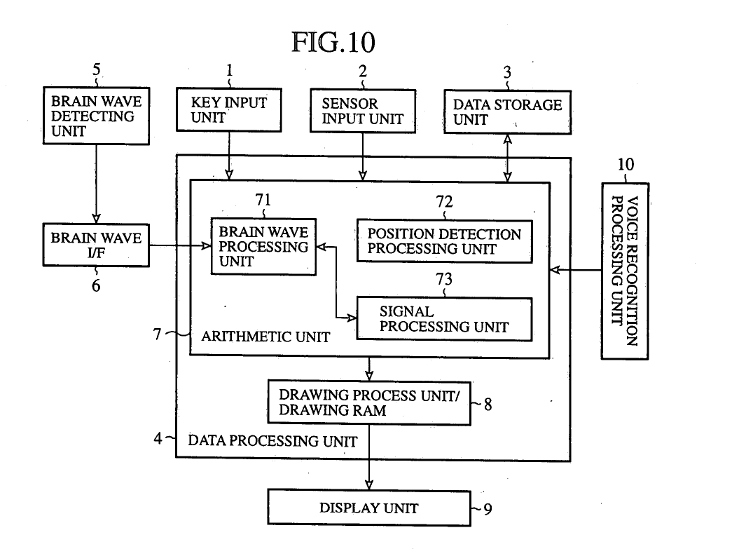

FIG. 10 is a block diagram showing the system configuration of a navigation apparatus intended for vehicles in accordance with embodiment 2 of the present invention. In the figure, the same components as those of embodiment 1 as shown in FIG. 1 or like components are designated by the same reference numerals, and therefore a repeated explanation of those components will be omitted hereafter. In FIG. 10, a voice recognition processing unit 10 (i.e., a voice recognition means) accepts a voice signal from a mike or the like which detects a driver's voice so as to generate the voice signal, and generates and sends a voice recognition signal to a signal processing unit 73 of an arithmetic unit 7. Therefore, the signal processing unit 73 has an internal structure different from that of the navigation apparatus as shown in FIG. 1.

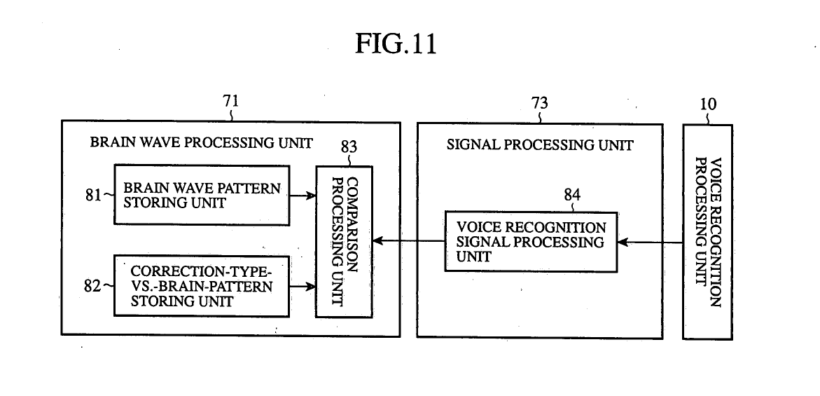

FIG. 11 is a block, diagram showing the internal structure of the signal processing unit 73, and a relationship between the signal processing unit 73 and both a brain wave processing unit 71 and the voice recognition processing unit 10. As shown in this figure, the signal processing unit 73 is provided with a voice recognition signal processing unit 84. The voice recognition signal processing unit 84 produces and stores a recognized pattern indicating a correction instruction by voice, i.e., a voice pattern based on a voice recognition signal received from the voice recognition processing unit 10. The voice recognition signal processing unit 84 sends the stored voice pattern to the comparison processing unit 83 of the brain wave processing unit 71 when the navigation is started.

The arithmetic unit 7 carries out a process of producing a voice pattern and storing it, as a correction pattern, in the voice recognition signal processing unit 84 while associating the voice pattern with a correction type according to a flow which is substantially the same as the flow of the brain wave pattern recognition processing of the navigation apparatus of embodiment 1 as shown in FIG. 4. In other words, the arithmetic unit 7 produces a screen display showing the name of each correction type, learns about voice pattern s produced from voice signals according to a user's key input operations, and stores a voice pattern associated with each correction type, as a correction pattern, in the voice recognition signal processing unit 84. In this voice pattern recognition processing, the arithmetic unit 7 determines whether it has detected a voice signal instead of determining whether it has detected a brain wave signal, in step ST103 of FIG. 3.

On the other hand, when the navigation is started, the arithmetic unit 7 advances to step ST5 of FIG. 3 in which it carries out brain wave detection processing, like that of the navigation apparatus of embodiment 1. In this case, the comparison processing unit 83 of the arithmetic unit 7 compares a brain wave pattern that is newly produced based on a detected brain wave signal and that is transmitted thereto from a brain wave pattern storing unit 81 with a plurality of correction patterns pre-stored in a correction-type-vs.-brain-wave-pattern storing unit 82. When then determining that a correction pattern substantially matching the received brain wave pattern exists in the correction-type-vs.-brain-wave-pattern storing unit 82, the comparison processing unit 83 further compares a voice pattern that is newly produced based on a detected voice signal, and that is transmitted thereto from the voice recognition signal processing unit 84 with a plurality of correction patterns concerning voice and pre-stored in the voice recognition signal processing unit 84. When then determining that a correction pattern substantially matching the received voice pattern exists in the voice recognition signal processing unit 84, the comparison processing unit 83 further determines whether the correction type associated with the correction pattern concerning brain wave matches the one associated with the correction pattern concerning voice. As a result, when the correction type associated with the corrections pattern concerning brain wave matches the one associated with the correction pattern concerning voice, the arithmetic unit 7 advances to step ST209 of FIG. 6 in which it determines whether or not the following issue of a correction instruction associated with the correction type is appropriate, and, when the following issue of the correction instruction is appropriate, carries out a correction process of correcting the displayed current position of the vehicle, like that of the navigation apparatus of above mentioned embodiment 1.

As mentioned above, in accordance with this embodiment the navigation apparatus can generate a correction instruction signal for instructing a correction of the displayed current position of a vehicle based on a brain wave acquired from a drivers head and a voice signal acquired from the driver's voice. Therefore when the displayed current position of the vehicle is different from an actual current position, the navigation apparatus can correct the displayed current position of the vehicle while the vehicle is moving without having to carry out error correction such as automatic correction (map matching) and without users having to conduct complex correction work.

Although the navigation apparatus in accordance with embodiment 2 is so constructed as to generate a correction instruction signal for instructing a correction of the displayed current position of the vehicle based on a brain wave acquired from the driver's head and a voice signal acquired from the driver's voice, the navigation apparatus can generate the correction instruction signal for instructing a correction of the displayed current position of the vehicle based on only a voice signal acquired from the driver's voice when it cannot generate any brain wave signal or when it is placed in a mode in which no brain wave signal is generated.

Many widely different embodiments of the present invention may be constructed without departing from the spirit and scope of the present invention. It should be understood that the present invention is not limited to the specific embodiments described in the specification, except as defined in the appended claims.

What is claimed is:

1. A navigation apparatus comprising:
a position detecting means for detecting a current position of a moving object according to positional information acquired from an information input means;
an instruction detecting means for detecting a correction instruction signal indicating a correction instruction for making a correction to a screen display on a display means and showing the current position of the moving object as a guided target for navigation, and for producing a recognized pattern based on the correction instruction signal;
a storage means for storing a plurality of types of correction patterns corresponding to a plurality of types of corrections to be made to said screen display;
a pattern determination means for determining whether said storage means stores a correction pattern substantially matching said recognized pattern by comparing said recognized pattern with said plurality of types of correction patterns;
a correction instruction determining means for determining whether or not an issue of said correction instruction is appropriate based on the current position of the moving object detected by said position detecting means and the one shown by said screen display on said display means when said pattern determination means determines that a correction pattern substantially matching said recognition pattern exists; and
a screen display correction means for making a correction to said screen display on said display means and showing the current position of the moving object according to said correction instruction when said correction instruction determining means determines that an issue of said correction instruction is appropriate.

2. The navigation apparatus according to claim 1, wherein said instruction detecting means is a brain wave detecting means for detecting a brain wave from the head of a driver who drives said moving object, and for generating a brain wave signal as the correction instruction signal from the detected brain wave.

3. The navigation apparatus according to claim 1, wherein said instruction detecting means is a voice recognition means for detecting a voice of a driver that drives said moving object, and for generating a voice signal as the correction instruction signal from the detected voice.

4. The navigation apparatus according to claim 1, wherein said instruction detecting means includes a brain wave detecting means for detecting a brain wave from the head of a driver who drives said moving object and for generating a brain wave signal from the detected brain wave, a voice recognition means for detecting a voice of the driver and for generating a voice signal from the detected voice, and a means for generating the correction instruction signal from the brain wave signal and the voice signal.

5. The navigation apparatus according to claim 1, wherein said apparatus further comprises an operation means for pre-storing, as said plurality of types of correction patterns respectively corresponding to said plurality of types of corrections, a plurality of recognized patterns which said instruction detecting means produces based on correction instruction signals detected thereby according to a user's operations.

6. The navigation apparatus according to claim 2, wherein said apparatus further comprises an operation means for pre-storing, as said plurality of types of correction patterns respectively corresponding to said plurality of types of corrections, a plurality of brain wave patterns which said brain wave detecting means produces based on brain wave signals detected thereby according to a user's operations.

7. The navigation apparatus according to claim 3, wherein said apparatus further comprises an operation means for pre-storing, as said plurality of types of correction patterns respectively corresponding to said plurality of types of corrections, a plurality of voice patterns which said voice recognition means produces based on voice signals detected thereby according to a user's operations.

8. The navigation apparatus according to claim 4, wherein said apparatus further comprises an operation means for pre-storing, as said plurality of types of correction patterns respectively corresponding to said plurality of types of corrections both a plurality of brain wave patterns which said brain wave detecting means produces based on brain wave signals detected thereby, and a plurality of voice patterns which said voice recognition means produces based on voice signals detected thereby, according to a user's operations.
